(19) United States
(12) Patent Application Publication
(10) Pub. No.: US 2020/0401936 A1
(43) Pub. Date: Dec. 24, 2020

(54) SELF-AWARE SERVICE ASSURANCE IN A 5G TELCO NETWORK

(71) Applicant: VMWARE, INC., Palo Alto, CA (US)

(72) Inventors: Radhakrishna Embarmannar Vijayan, Bangalore (IN); Thatayya Naidu Venkata Polamarasetty, Bengaluru (IN)

(21) Appl. No.: 16/535,121

(22) Filed: Aug. 8, 2019

(30) Foreign Application Priority Data
Jun. 20, 2019 (IN) 201941024554

(51) Int. Cl. G06N 20/00

(52) U.S. Cl. CPC G06N 20/00

(57) ABSTRACT

Examples herein describe systems and methods for self-aware service assurance in a Telco network. A machine learning engine can receive key performance indicators (“KPIs”) and physical faults related to virtual and physical network components, respectively. The machine learning engine can apply spatial and temporal analysis to define how models process the KPIs and faults and issue alerts for predictively remediating the network components. The machine learning engine can analyze the impact of these alerts on network health. This can include experimenting with different alert models and tuning how the machine learning engine processes the KPIs and faults based on which models are positively impacting network health compared to others. Based on newly detected patterns, event correlations, and anomalies, the machine learning engine can tune the model criteria to more accurately prevent problems from occurring.

### CROSS-REFERENCE TO RELATED APPLICATION

This application claims the benefit under 35 U.S.C. 119(a)-(d) to Foreign Application Serial No. 201941024554 filed in India entitled “SELF-AWARE SERVICE ASSURANCE IN A 5G TELCO NETWORK”, on Jun. 20, 2019, by VMWARE, Inc., which is herein incorporated in its entirety by reference for all purposes.

### BACKGROUND

Enterprises of all types rely on networked clouds and datacenters to provide content to employees and customers alike. Preventing downtime has always been a primary goal, and network administrators are armed with various tools for monitoring network health. However, the virtualization of network infrastructure within datacenters has made it increasingly difficult to anticipate problems. It is estimated that 59% of Fortune 500 companies experience at least 1.6 hours of downtime per week, resulting in huge financial losses over the course of a year. Existing network monitoring tools do not effectively predict problems or service degradation based on key performance indicators (“KPIs”). As a result, failures occur before the underlying causes are remediated.

Some information technology (“IT”) operational tools provide analytics and loop-back policies for analyzing virtual infrastructure. However, these generally analyze the overlay of the virtual infrastructure, meaning a virtual layer of abstraction that runs on top of the physical network. These do not account for the interactions between physical networking components and the virtual ones. This is becoming increasingly important because software-defined networks (“SDNs”), virtual network functions (“VNFs”), and other aspects of network function virtualization (“NFV”) rely on both the physical and virtual layers and are constantly adapting to meet data availability needs. Using NFV in the Telco cloud, network providers are able to quickly deliver new capabilities and configurations for various business and competitive advantages. This virtualization has led to more data availability than ever before, with even more promised based on widespread 5G technology adoption.

The expansion of 5G also brings an increased need to detect and prevent problems without constant human involvement. To allow for increased stability, a need exists for systems to become aware of issues between the virtual and physical layers. Widespread data availability will only increase the need to rapidly detect problems that lead to network downtime. Self-aware technologies are needed to recognize these issues with minimal human input.

As a result, a need exists for self-aware service assurance in a 5G Telco network.

### SUMMARY

Examples described herein include systems and methods for self-aware service assurance in a 5G Telco network. In one example, a machine learning engine receives KPIs of a virtual component in a network. The KPIs can indicate one or more of packet drops, input packet rate, output packet rate, read latency, write latency, throughput, number of operations, and others. The machine learning engine can also receive physical fault information from a physical component in the network.

In combination, the KPIs and physical fault information can be used to predict issues within a software-defined data center (“SDDC”) that spans one or more clouds of a Telco network. For example, the machine learning engine can process the KPIs and physical fault information by using spatial analytics to link KPIs to physical faults happening at the same time slice, which is a short period of time, such as a minute. This can allow the ML engine to tune a model used to detect potential problems and issue alerts. For example, the model can have various criteria with dynamic thresholds that can be used to determine when a problem is present. The thresholds can be selected by the ML engine based on temporal analysis, whereby KPI patterns are learned for particular periods of time and thresholds can be set to indicate anomalous deviations. Similarly, co-existent symptoms can be recognized with the spatial analysis, which can recognize various events occurring at the same time. In this way, a model can evolve that has as symptoms a collection of KPIs, faults, and dynamic thresholds for comparison in order to predict a problem.

When a model's symptom criteria are met, the machine learning engine can issue an alert to an orchestrator for performing a corrective action to the virtual or physical component. These models can allow the system to perform a root cause analysis (“RCA”) based on KPIs and faults. The alert can be based on a combination of symptoms being met. In one example, the alert includes information about the virtual component and the physical component.

In addition to dynamically setting the KPI thresholds of the models, the machine learning engine can adjust the machine learning techniques it uses to build the models. For example, the machine learning engine can analyze a change in network stability for criteria from one algorithm relative to another. The change can be recognized based on a change in a frequency of subsequent alerts for related network objects, in an example. For example, if subsequent alerts do not decrease beyond a threshold amount or percentage, the change in network stability may warrant adjusting how the machine learning engine makes predictions. Based on the change in network stability, the machine learning engine can adjust the processing of KPIs. This can include changing which KPIs are considered symptoms to a problem, changing the KPI thresholds, or swapping machine learning algorithms for determining the symptoms and thresholds.

In one example, an administrator can use a graphical user interface (“GUI”) to select which KPIs are used for the processing by the machine learning engine. The machine learning engine can then adjust its processing based on the change in network stability by changing which KPIs are used for the processing. In this way, the KPIs used can evolve from those originally selected by the administrator, in an example. The machine learning engine can collect and store KPI data in a time series database in association with domain information. The domain can indicate a use of the data. The domain can be used to select a first machine learning technique for temporal or spatial analysis.

Analyzing the change in network stability can include both temporal and spatial analysis. Temporal analysis is based on analysis over a period of time, such as by analyzing collected time series data to determine behavior anomalies. The spatial analysis is based on events occurring at the same time, such as faults occurring at the same time of KPI anomalies. The KPIs can be part of an alert sent from a virtual analytics engine that monitors a virtual layer of the Telco cloud. The virtual analytics engine can generate KPI-based alerts by comparing attributes of VNF performance against KPI thresholds.

The machine learning engine can also receive a physical fault notification that includes hardware information about a physical device in the Telco cloud. The physical fault notification can be sent from a physical analytics engine that monitors for physical hardware faults at devices in a hardware layer of the Telco cloud. In one example, the machine learning engine tracks relationships between physical and virtual components by storing objects in a graph database. The objects can represent multiple physical components and multiple virtual components. Edges between the objects indicate relationships. Then, for linking events between objects more quickly, the machine learning engine can cache at least some of the objects for real-time use in the analysis stage.

The method can be performed as part of system that includes one or more physical servers having physical processors. The processors can execute instructions to perform the method. In one example, the instructions are read from a non-transitory, computer-readable medium. The machine learning engine can then execute as part of an SDDC topology. For example, the machine-learning engine can be configured to receive inputs from various analytics applications that supply KPIs from the virtual layer or fault information from the physical layer. Then machine learning engine can then interact with an orchestrator or some other process that can take corrective actions based on the findings of the machine learning engine.

Both the foregoing general description and the following detailed description are exemplary and explanatory only and are not restrictive of the examples, as claimed.

### BRIEF DESCRIPTION OF THE DRAWINGS

FIG. 1 is a flowchart of an example method for performing self-service assurance in a Telco cloud.

FIG. 2 is a sequence diagram of example steps for self-aware service assurance in a Telco cloud.

FIG. 3 is an example system diagram including components for self-aware service assurance in a Telco network.

FIG. 4 is an example system diagram including components for self-aware service assurance in a Telco network.

FIG. 5 is an example diagram of functionality performed by the machine learning engine.

FIG. 6 is an example system architecture diagram including components and stages for self-aware service assurance in a Telco network.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

In one example, a machine learning (“ML”) engine can help prevent datacenter problems and dynamically provide service assurance in a Telco cloud environment. The ML engine can be a framework or topology that runs on a physical server. The ML engine can analyze both KPIs and physical faults together to determine a predictive action for an orchestrator or other process to implement. In particular, the ML engine can evolve models that include various co-related symptoms with dynamic thresholds. Spatial analytics can determine co-related symptoms by looking for anomalies that occur at the same time slice. This can, for example, result in a model that looks at particular KPIs and faults together at the same time. The thresholds themselves can be chosen by the ML engine based on recognizing patterns in KPI values and faults using temporal analysis. Temporal analysis can recognize value patterns during certain times of day, days of the week, or months of the year, for example. Based on those patterns, KPI and fault thresholds representing deviations can be selected and used in the models. When the correct combination of KPI thresholds are exceeded and faults are present, the ML engine can then issue an alert that can allow a destination, such as an orchestrator process, to proactively make changes that can help prevent negative user experience due to network problems.

In addition to issuing these alerts, the ML engine can further tune the predictive processing by analyzing changes in network stability resulting from the current models. If network stability does not change a threshold amount, the ML engine can change which KPIs are processed for predictive actions or select different machine learning algorithms for determining symptoms and thresholds. This can, over time, change the models by which the KPIs and faults are linked to determine alerts and corrective actions. Finally, algorithms for temporal and spatial analysis can be changed such that new ML techniques are incorporated. For example, the ML engine can test new algorithms to generate new test models, and if these result in more network stability relative to the current algorithms and models, the new algorithms can be prioritized or even used in place of the current algorithms. The ML engine can continue to analyze network stability and tune the model symptoms, thresholds, and algorithms based on evidence of network stability advantages.

In applying a model to KPIs and faults, the ML engine can map virtual machine (“VM”) activity to physical hardware activity based on information received from a KPI engine and a fault detection engine. The KPI engine, also referred to as a VM overlay or virtual overlay, can monitor and report KPIs of the VMs in the Telco cloud. An example KPI engine is VMware®'s vRealize®. The fault detection engine, also referred to as a hardware analytics engine or HW overlay, can perform service assurance of physical devices such as hardware servers and routers. This can include reporting causal analysis, such as packet loss, relating to the physical hardware of the Telco cloud. In one example, the ML engine operates together with the KPI and fault detection engines, and together can consist of one or more applications executing on one or more physical devices.

The ML engine can map the physical and virtual components so that the KPI analytics and causal analytics using a graph database, evaluating KPIs and faults together as part of root cause analysis (“RCA”). The mapping can be done based on alerts received from both the virtual (KPI) and hardware (fault detection) engines, which can identify particular virtual and physical components. In one example, the ML engine can predict whether a software or hardware problem exists by comparing the mapped virtual and physical information to action policies of an ever-evolving model. The model can specify prediction criteria and remedial actions, such as alerts to notify an admin or scripts for automatic remediations. As examples, a service operations interface can provide an administrator with an alert regarding a physical problem. In another example, based on the alert from the ML engine, the orchestrator process can automatically instantiate a new VNF host to replace another that is failing.

In one example, a ML engine can continuously adjust the prediction criteria, algorithms, KPIs, or thresholds based on analyzing the impact of its alerts on network performance. This ML engine can therefore lend a self-aware quality to the datacenter, reducing the burden on human operators. As Telco cloud datacenters increase in complexity, using analytics from the virtual and physical layers to detect potential issues in the other layer, all based on effectiveness in stabilizing the network, can help remediate issues before catastrophic failures occur, unlike current systems.

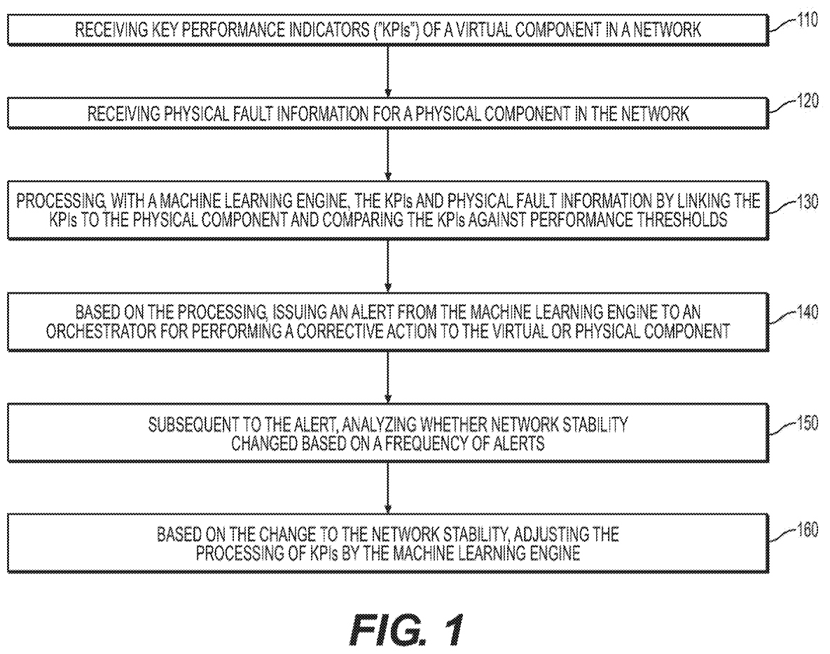

FIG. 1 is an example flowchart of steps performed by a system for self-aware service assurance in a Telco NFV cloud. The Telco cloud can be one type of distributed network, in which network functions are located at different geographic locations. These locations can be different clouds, such as an edge cloud near a user device and core clouds where various analytics engines can execute.

At stage 110, the ML engine can receive KPIs relating to a virtual component, such as a VNF. In one example, the ML engine can operate separately and remotely from the virtual or physical analytics engine. This can allow the ML engine to be offered as service to network providers, in an example. Alternatively, the ML engine can be an application or VM executing on a server. The ML engine can also be part of the virtual analytics engine or the physical analytics engine, in different examples. These engines also can be applications or VMs executing on a physical device, such as a server.

In one example, the ML engine receives the KPIs from a virtual analytics engine. The virtual analytics engine can act as a virtual overlay that provides analysis and management features for a virtual datacenter, such as a datacenter that uses VMs on a Telco cloud. One such virtual overlay is VMware®'s vRealize®. The virtual analytics engine can provide dynamic thresholding of KPIs, including a historical time series database for analytics, in an example. The virtual analytics engine can provide KPIs in the form of alerts when KPI thresholds are breached. The alerts can be configured and based on policy files, which can be XML definitions.

The virtual analytics engine therefore manages information coming from a virtual layer of a network. Traditionally this has involved very limited connectivity with physical devices by an enterprise network, rather than the massive connectivity of a Telco cloud. Although virtual analytics engines primarily have had enterprise customer bases to this point, examples herein allow for using virtual analytics engines with a customer base that manages distributed networks, such as a Telco cloud.

The KPIs can include performance information of a virtual component, such as a VM or VNF. The KPIs can indicate one or more of packet drops, input packet rate, output packet rate, read latency, write latency, throughput, number of operations, and others. In one example, the KPIs are sent to the ML engine when the virtual analytics engine determines that particular measured metrics exceed a performance threshold, fall below a performance threshold, or are otherwise anomalous. For example, if a number of packet drops exceeds a threshold during a time period, then the virtual analytics engine can send corresponding KPIs to the ML engine. The KPIs can be sent in a JSON or XML file format.

At stage 120, the ML engine can receive physical fault information relating to a physical component, such as a hardware server or router. A fault detection engine (also called a “physical analytics engine”) can determine and send the fault notification to the ML engine. The fault information can be a notification or warning, in one example. For example, the fault detection engine can monitor for hardware temperature, a hardware port becoming non-responsive, packet loss, and other physical faults. Physical faults can require operator intervention when the associated hardware is completely down.

The fault detection engine can perform causal analysis (for example, cause and effect) based on information from the physical layer. This can include a symptom and problem analysis that includes codebook correlation for interpreting codes from hardware components. One such physical analytics engine is Smart Assurance®. In one example, physical fault notifications can be generated based on a model of relationships, including a map of domain managers in the network. The physical analytics engine can manage information coming from the physical underlay in the Telco cloud. Various domain managers can discover the networking domain in a datacenter. Models generated by the virtual analytics engine can be used to provide cross-domain correlation between the virtual and physical layers, as will be described.

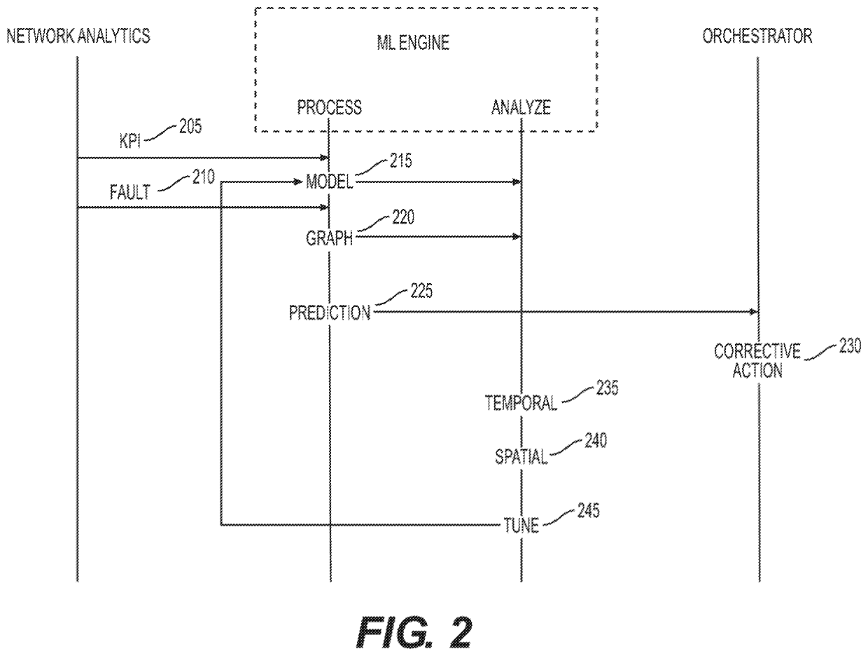

At stage 130, the ML engine or some other engine (e.g., a correlation engine) can process the KPIs and physical fault information to determine whether to issue an alert. As will be discussed in FIG. 2, a model can be generated and tuned over time that defines which KPIs, faults, and thresholds are used to determine a potential problem. These criteria can be tuned based on the machine learning recognizing patterns, anomalies, and co-existent events in the network. For example, symptoms can be selected based on spatial analysis that links events at the virtual component and the physical component. The symptoms can include dynamic KPI thresholds.

In one example, if the symptoms in a model are met, the ML engine or some other process can issue an alert. The alert can notify an orchestrator to perform a corrective action, such as re-instantiate a VNF or message a service about a failing physical device.

To tune the models repeatedly over time, the ML engine can perform spatial and temporal analysis in an example. This can involve utilizing one or more machine learning algorithms. An initial configuration of ML techniques for one example is shown below in Table 1:

TABLE 1

| | Use Case | Domain | ML Technique |
|---|---|---|---|
| Temporal | Periodicity and Growth | Fault Prediction | Linear |
| Analysis | analysis for a KPI | | Regression |
| | Frequency mining of a | Fault Prediction | Linear/ |
| | KPI over a period of | | Logistic |
| | time | | Regression |
| | Anomaly detection of a | Anomaly | Linear |
| | KPI over a period of | Detection | Regression, |
| | time | | k-means |
| Spatial | KPI + time slice + | Fault Prediction | k-means, |
| Analysis | other faults & KPI at | | Hidden |
| | same time slice and | | Markov |
| | making a prediction | | |
| | Grouping affinity | Fault | Q-Learning, |
| | related KPIs/faults | Localization/ | k-means |
| | for a given time slice | Affinity Analysis | |
| | and making a prediction | (Clustering − | |
| | | Unsupervised) | |

Table 1 shows three initial ML techniques for temporal analysis and two initial ML techniques for spatial analysis. Each domain, such as fault prediction, can have multiple ML techniques that can be used by the ML engine. For example, fault prediction for frequency mining of a KPI over time can be accomplished with a linear regression algorithm and a logistic regression algorithm. In one example, the ML engine can use multiple algorithms and test which one works more effectively over a period of time for improving network health. This can include determining which ML technique generates symptom criteria that results in fewer network problems for components implicated by the model. The ML engine can tune how the model utilizes KPIs as symptoms based on which algorithms are working best.

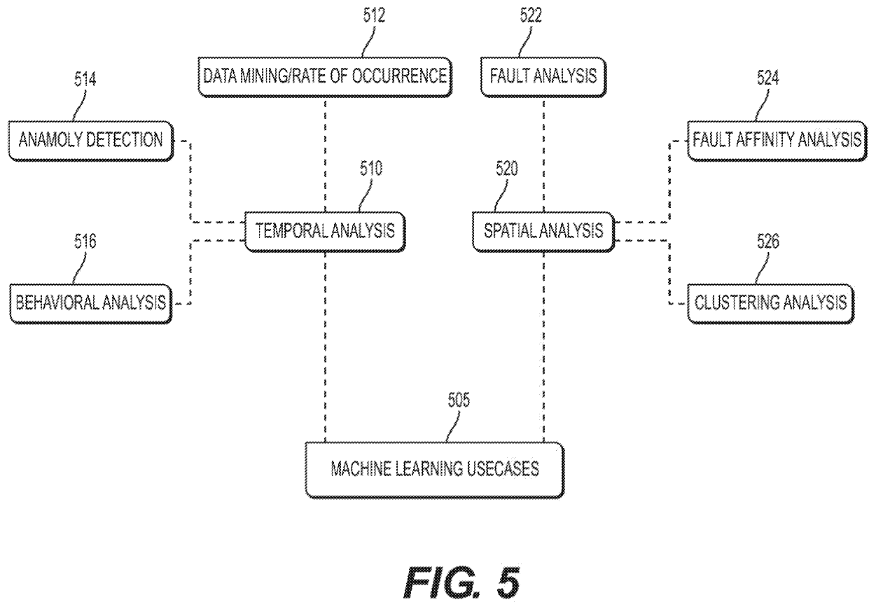

The temporal analysis can involve recognizing KPI and fault patterns in particular time periods. The spatial analysis can involve linking events that occur at the same time in the virtual and physical domains. Both spatial and temporal analytics are discussed in greater length below with regard to FIG. 5. But these two types of analytics can allow the ML engine to link various KPIs exceeding various thresholds with one or more faults and tune the model accordingly. In other words, the ML engine can recognize patterns that span both the virtual and physical layers and apply those insights to the models used for detecting problems.

To link the two types of information, the ML engine can use a topology of mapping services to associate the particular virtual components to hardware components. In one example, this is done by maintaining a graph database in which the nodes (objects) represent virtual and physical components. Edges between the nodes can represent relationships. In this way, a graph database can, for example, link VNFs to particular hardware.

The graph database can allow the ML engine to more accurately correlate the KPIs and fault information by linking the virtual and physical components, in an example. The topology represented by the graph database can continually and dynamically evolve based on a data collector framework and discovery process that creates the topology based on what is running in the Telco cloud. The discovery process can account for both physical and virtual components.

Discovery of physical components can include identifying the physical servers, routers, and associated ports that are part of the Telco cloud. The discovery process can be periodic or continuous. In one example, the physical analytics engine, such as Smart Assurance®, performs the hardware discovery and creates a physical model to track which hardware is part of the Telco cloud. This can include identifying hardware along with certifications pertaining to that hardware. This information can be reported to the physical analytics engine. The physical model can further include identification of bridges, local area networks, and other information describing or linking the physical components.

Discovery of virtual components can include identifying VNFs that operate as part of the Telco cloud. The VNFs can represent virtual controllers, virtual routers, virtual interfaces, virtual local area networks (“VLANs”), host VMs, or other virtualized network functions. In one example, the virtual analytics engine can discover virtual components while the physical analytics engine monitors discovered hardware components. The hardware components can report which VNFs they are running, in one example. By discovering both the hardware and virtual components, the system can map these together.

The temporal analysis can include pattern matching between faults and KPI information. It can also include dynamic thresholding, in which KPIs are compared to thresholds that change based on the recognized patterns during a time period. The patterns and dynamic thresholds can be recognized according to a model. Initially, the model can operate based on a customer configuration that includes a list of KPIs to be analyzed by the ML engine and recommended algorithms for doing so. This model can be subject to a test-experiment-tune process of the ML engine.

Over time, the ML engine can automatically change (tune) the model, such as by emphasizing different KPIs, emphasizing different algorithms or changing algorithms altogether, and changing dynamic KPI thresholds. This tuning, as will be described, can be based on network stability analysis by the ML engine. For example, the model can be changed based on temporal and spatial analysis. As will be more elaborately explained later, the temporal analysis can include pattern recognition based on historical data from a time series database (“TSDB”). The spatial analysis, on the other hand, can be focused on contemporaneous faults and KPIs that occur concurrently, based on the relationships in the graph database. The ML engine can use both to shape the model through which issues are detected and alerts are sent.

At stage 140, when the current model indicates an alert is needed, the ML engine can issue an alert to an orchestrator. The orchestrator can be a software suite for managing virtual entities (e.g., VNFs, VMs) and communicating with the physical analytics engine or other software for managing physical devices.

Based on the alert, the orchestrator can cause a corrective action to be performed on the virtual or physical component implicated by the alert. The alert can include a suggested remedial action in one example. The remedial action can be based on an action policy file. The action policy file can map alerts, object types, and remedial actions to be taken. The action policy file can be an XML file, JSON file, or a different file format. The self-healing engine can utilize a single action policy file that defines multiple different remedial actions, in one example. Alternatively, the self-healing engine can utilize multiple different action policy files, each one containing one or more remedial actions. An action policy file can address how to respond to a particular type of information.

In addition to a suggested remedy, the alert can include other information that can help an orchestrator implement the remedy. This other information can come from one or more analytics engines, such as the virtual analytics engine and the physical analytics engine. For example, an alert object can include information about the source of the alert, the type of alert, and the severity of the alert. In one example, an alert object can contain identifying information regarding the component to which the alert relates. For a virtual component, the identifying information can include a unique string that corresponds to a particular VNF. For a hardware component, the object can identify a rack, shelf, card, and port. The action policy file can specify different actions based on the identifying information. For example, if a particular VNF is implicated, the self-healing component can send a new blueprint to an orchestrator associated with that VNF, resulting in automatic deployment of the VNF to other physical hardware that is not experiencing a physical fault. An orchestrator can be a service that is responsible for managing VNFs, including the identified VNF, in an example.

The ML engine can send the alert to various destinations, such as an orchestrator with management capabilities for a VNF, a network configuration manager (“NCM”) that manages physical hardware, or some other process capable of receiving requests. The ML engine can also use one or more action adaptors that can translate the action into a compatible request (for example, a command) at the destination. In an alternate example, the destination can be specified in the action policy file in one example.

As one remediation example, the adaptor can specify a network configuration job based on a remedial action defined in the action policy file. The network configuration job can be created in a format compatible with the NCM that operates with the physical hardware. In one example, the NCM is part of the physical analytics engine. For example, the adaptor can format a network configuration job for implementation by Smart Assurance® or another NCM. Performing the remedial action in this way can cause the NCM to schedule a job for performance. For remedial actions in the physical layer, example jobs can include sending a configuration file to the physical device, sending an operating system (“OS”) upgrade to the physical device, restarting the physical device, or changing a port configuration on the physical device.

For example, a first adaptor can receive an alert object that includes: “Port, Port-1-1-2-3-1, Critical, ‘Error packets beyond threshold’, Physical SW.” The first adaptor can translate this into a request (for example, a command) to send to a particular NCM, which can make a software change to potentially avoid a hardware problem. The self-healing component can send the request to the NCM in a format that allows the NCM to schedule a job to remedy the error relating to the packets issue. This can include pushing a configuration file to the physical hardware, in one example. It can also include updating an OS version.

An adaptor can also translate actions in the policy action file into commands for an orchestrator associated with a VNF. For example, the adaptor can generate one or more commands that cause the orchestrator to invoke a new virtual infrastructure configuration action. These commands can include sending a new blueprint to the orchestrator. A blueprint can indicate which VNFs should be instantiated on which physical devices. For remedial actions in the virtual layer, additional example commands can invoke a load balancing change or an instantiation of a VM.

As another example, a second adaptor can receive an alert object that includes: “VNF, VNF-HostID-as23ds, Critical, ‘Service degradation beyond threshold,’ Virtual SW.” The adaptor can send a remediation request (for example, a command) to a process with managerial control over the VNF. The process can be an orchestrator or virtual analytics engine. Upon receiving the request, the process can make a load balancing move, in an example. In one example, the orchestrator can implement a blueprint that specifies a virtual infrastructure, resulting in a VNF being deployed, for example, at a different host or using a different port. The blueprint can be created in response to the command in one example. Alternatively, the self-healing component can provide a blueprint or portion of the blueprint to the orchestrator or virtual analytics engine.

In addition to providing alerts for self-healing, the ML engine can also analyze the effectiveness of those alerts at stage 150. For example, the ML engine can analyze whether network stability changes based on temporal and spatial analysis. The temporal analysis can include tracking whether fewer faults are detected by the hardware related to the alert or a virtual component implicated by the alert. In one example, if the number of related alerts generated by the ML engine decrease over time, this can be an indicator that network health is changing for the better. However, if the number of related alerts stays the same or increases, then this can indicate that network health is not improving enough.

Based on analyzing this change in network health, at stage 160 the ML engine can tune (adjust) how it is processing the KPIs at stage 130. This can include changing which KPIs are evaluated. It can also include emphasizing one algorithm over another or changing algorithms altogether.

Although an operator can select initial ML Techniques in Table 1 for the various domains in one example, the ML engine can adjust which ML Techniques are used over time. For example, the ML engine can analyze improvements to network health based on alerts generated by each of the ML techniques. If a particular technique causes a negative change in like-kind alerts over time, or if like-kind alerts do not decrease to a stable threshold level, then the ML engine can choose a new ML Technique. There can be multiple different varieties of a particular ML Technique as well. For example, regression analysis can take on many varieties, and the ML engine can test between these varieties in determining which ML Technique improves network health the most. Additionally, dynamic thresholds based on the detections by the ML technique can be adjusted. For example, standard deviation from a linear regression can be used to determine a dynamic threshold of KPI values for a particular time and day of the week. When KPIs exceed that deviation-based threshold, then a true anomaly can be detected.

In this way, the ML engine can provide self-aware service assurance by tuning its detection of predictive alerts.

FIG. 2 is an example sequence diagram for self-aware service assurance. At stage 205, the ML engine receives KPIs describing virtual component performance. These can be received from a network analytics process, such as the virtual analytics engine (e.g., vRealize®). These KPIs can be above a threshold that causes the networks analytics process to report them to the ML engine, in an example. The KPIs can include performance information of a virtual component, such as a VM or VNF. The KPIs can indicate one or more of packet drops, input packet rate, output packet rate, read latency, write latency, throughput, number of operations, and others. Likewise, at stage 210, the ML engine can receive physical fault information from a network analytics process, such as a fault engine (e.g., Smart Assurance®).

Both types of information can be processed by the ML engine based on a model at stage 215. The model can be built or tuned by the ML engine's use of a graph database at stage 220. For example, the ML engine can use spatial analytics to correlate the KPIs and faults based on network relationships indicated by the graph database. This can help tune the collection of symptoms in the model that are simultaneously present in predicting a problem. This ML engine can use the graph database (or cached subset) in performing spatial analysis at stage 240 to determine relationships between cross-domain events during a time slice. The ML engine can also apply temporal analysis at stage 235 to determine patterns over time periods and establish thresholds for KPIs. These thresholds can then be applied as dynamic thresholds in a model.

An example dynamic threshold model can be defined as follows:
Model Virtual Performance Threshold {
attribute is Packet Threshold Exceeded;
attribute packetDrop;
attribute packetRate;
attribute outputPacketRate;
SYMPTOM PacketThresholdBreach isPacketThresholdExceeded;
SYMPTOM ErrorPacket (packetDrop>70);
SYMPTOM InputPacketRate (packetRate<50);
SYMPTOM OutputPacketRate (packetRate<50);
PROBLEM (PacketThresholdBreach && ErrorPacket && InputPacketRate && OutputPacketRate)}

In this example, the dynamic threshold model includes KPI comparisons such as whether a packet maximum is exceeded, a number of packet drops, an input packet rate, and an output packet rate. The thresholds can be set by user selection initially but tuned based on the network health analysis at future stages. For example, the threshold values themselves (e.g., 70, 50, 50) can be learned from the temporal analysis at stage 235, in an example. For example, the ML engine can increase and decrease thresholds based on patterns recognized during temporal analysis, then test those new thresholds. If network health increases (e.g., relatively less alerts for similar or same components), then the ML engine can tune the model by applying the new thresholds. Still newer thresholds can be developed and tested through future temporal analysis.

The symptoms themselves can be determined and tuned based correlations discovered by the spatial analysis in stage 240, in an example. As time goes on, further tuning can result in a different collection of symptoms having different thresholds. Together, the symptoms can define which KPIs are compared to which dynamic thresholds.

The first symptom in this example is whether the packet maximum is exceeded. This symptom can be an anomaly represented by a Boolean expression. The next three symptoms include comparing the number of packet drops to a threshold of 70 or comparing packet rates to a threshold of 50. This virtual threshold model defines a problem as existing when any of the symptoms are true.

When a problem exists, at stage 225 the ML engine can send a predictive alert to a destination associated with the root cause object. The ML engine can determine the destination from the graph database in one example. For example, the destination can be an orchestrator. The graph database can represent cross domain correlation between an IP listing of layer 3 physical devices (for example, switches, routers, and servers) and an enterprise service manager (“ESM”) identification of virtual components, such as VNFs. The alert sent to the destination (e.g., orchestrator) can include a root cause analysis (“RCA”) used by the destination for performing the remedial action. The RCA can be a hardware alert that is sent to the self-healing component. The RCA can come from the physical or virtual analytics engine and identify at least one virtual component (for example, VNF) whose KPI attributes were used in detecting the problem along with the correlating physical hardware device.

At stage 230, the orchestrator can implement a remedial action based on the alert. This can include directly remediating a virtual component, such as a VNF, in an example. The alert can include a suggested remedial action in one example. The remedial action can be based on an action policy file. The action policy file can map alerts, object types, and remedial actions to be taken. The action policy file can be an XML file, JSON file, or a different file format. The self-healing engine can utilize a single action policy file that defines multiple different remedial actions, in one example. Alternatively, the self-healing engine can utilize multiple different action policy files, each one containing one or more remedial actions. An action policy file can address how to respond to a particular type of information.

The ML engine can continue to analyze the effectiveness of its alerts in stages 235 and 240. Then, based on this further analysis, the ML engine can tune how the model generates alerts at stage 245. Stage 245 can include tuning the model by adjusting the thresholds or algorithms used to determine alerts.

In more detail, at stage 235, the ML engine can analyze network health by using temporal analysis. Temporal analysis can utilize data in a time-series database. The time series database can store KPIs for a particular object in the graph database, such as dropped calls or packet drops. For example, a router's anomalies over the course of a day, month, and year can be tracked. This can allow the ML engine to recognize patterns over time to determine if the alerts are effective.

Some temporal analysis can reveal abnormal rates of event occurrence. In one example, the collected time series data can be analyzed for a number of occurrences or repetition of the same behavior over a period of time. For example, the number of instances of an increase in edge router packet loss beyond a baseline threshold can be analyzed for predicting a likely occurrence in the future during a particular time, day, week, or month. Another temporal analysis could show that the number of instances of video call drop faults does not reduce significantly before or after a proactive remediation. This could cause the ML engine to tune at stage 245 by changing correlation between the video call drop faults and the current remediation and start sending alerts based on the particular time in which packet loss occurs.

The temporal analysis of stage 235 can also involve behavior analysis. For example, peak utilization can be observed at a particular time of day and used to understand KPI anomalies that occur at that time based on the expected effects of overutilization. Similarly, if network components are delayed, packet loss analysis can have a periodicity that takes these delays into account. The behavior analysis can also be cross domain between physical, virtual, and mobile for a given 5G service, in an example, through use of the graph database. These discoveries can be built into the model at the tuning stage 245.

The temporal analysis can also be used for anomaly detection. An increase or decrease of a metric over a period of time with respect to a baseline threshold can be considered an anomaly. For example, a video service degradation due to increase in call drop ratio likely impacts the end-customer experience. By detecting this anomaly, an alert that causes predictive load balancing can prevent the negative customer experience. Therefore, the ML engine can tune the model accordingly at stage 245.

Similarly, an increase or decrease in a KPI can be used for anomaly detection and tuning by introducing predictive actions. For example, an increase in packet loss of an edge router and packet drops of another router can in conjunction cause video service degradation, leading the ML engine to tune at stage 245 to include a corresponding alert in the model used for processing at stage 215.

Temporal analysis can detect similar anomalies in hardware. Hardware attributes such as processor load, memory load, disk load, voltage, time sensors, fan speed occurring at the same time slice can be used to predict the hardware failure. For example, an increase in both voltage and temperature sensors at the same time can warrant an alert based on past hardware failures. The ML engine can tune the model accordingly at stage 245.

At stage 240, the ML engine can incorporate spatial analysis, where ML techniques are used to analyze concurrent events in the same time slice. For example, having observed that a database service hosted on a VM has degraded performance, causing application slowness, spatial analytics can identify other performance issues occurring at the same time. For example, traffic flow parameters of a router can show anomalies at the same time along with jitters and increase in delay of edge routers. This can allow the ML engine to tune the model at stage 245 to use future anomalies with the database service or router to address the other network component.

As another example, the ML engine can observe video service degradation in a VNF. Using spatial analysis, the ML engine can identify other faults occurring at the same time. For example, an increase in temperature and voltage of a physical router and packet loss in another router can be observed. This can be used to tune the model at stage 245 by including these other devices in alerts related to the video service degradation.

Any or all of these techniques can result in tuning at stage 245, when a change in network health indicates new modeling is required at the processing stage 215.

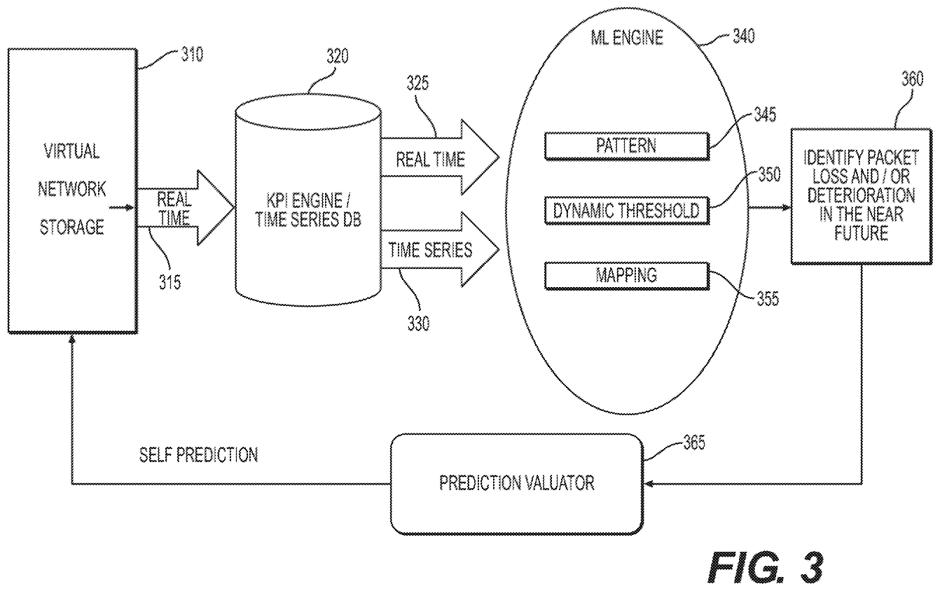

FIG. 3 illustrates system components operational in a sample use case of the ML engine. Network analytics processes 310 supply real-time information 315 regarding virtual, network, and storage components of the network to a KPI engine 320. The real-time information 315 can represent, for example, data plane development kit (“DPDK”) packet loss. The KPI engine 320 can be part of the virtual analytics engine in an example, providing KPIs related to virtual components.

The KPI engine 320 can apply dynamic thresholding to this real-time information 315 to determine anomalies and pass those as real-time KPIs 325 to the ML engine 340 for processing. For example, the KPIs 325 can represent a current packet drop rate and percentage for a virtual component. The KPI engine 320 can utilize the time series database to convert the information 315 to KPIs 325 in one example. The KPI engine 320 can also send some of these KPIs to the time series database, which is represented together with the KPI engine 320 here for simplicity. The ML engine 340 can likewise utilize time series data 330 from the time series database along with the real-time KPIs 325 from the KPI engine 320. For example, the time series database can supply historical values of packet drop rate and percentage.

Using the real time KPIs 325, such as current packet drop rate and percentage, with the time series data 330, which supplies historical context, the ML engine 340 can apply models based on ML techniques to determine whether to issue an alert. This can include pattern matching 345, dynamic thresholding 350, and mapping 355 network components across domains. For pattern matching 345, the ML engine 340 can determine if a history of events fall under a pattern and whether the real-time KPIs 325 also fall into or deviate from the pattern. This can be based on applying dynamic thresholds 350 developed from historical patterns to the real-time KPIs 325, such as current packet drop rate and percentage. The ML engine 340 can also perform mapping 355 to determine associations between a virtual switch and the physical network, using the graph database.

Together, this analysis can allow the ML engine 340 to determine if the DPDK packet loss matches or establishes a trend involving particular network components. In the example of FIG. 3, this can include identifying packet loss and near-future performance deterioration of specific network components, such as the virtual switch and underlying physical hardware, as indicated by element 360. The ML engine 340 can issue an alert as a result. The alert can be sent to a destination, such as an orchestrator, that can cause a corrective action to occur. A prediction valuator component 365, which can be part of the ML engine 340 or the destination (such as an orchestrator), can then make a predictive action that gets implemented by one or more network components. The ML engine 340 can observe the results based on data from the network analytics services 310 regarding those same network components.

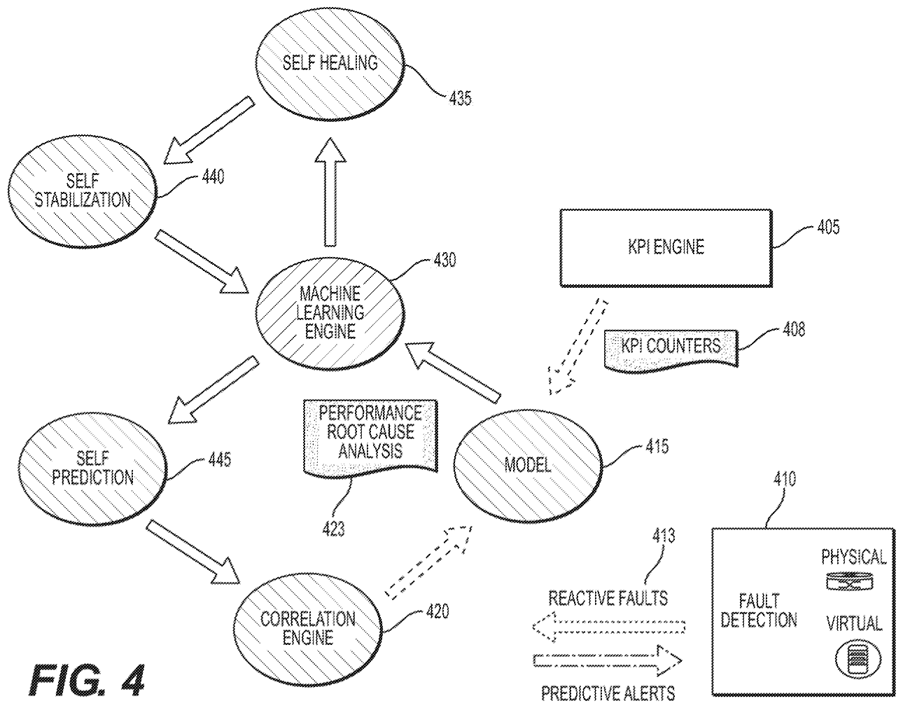

FIG. 4 is another exemplary illustration of system components for self-aware service assurance in a Telco cloud. Analytics engines such as the fault detection engine 410 can detect events in the physical and virtual layers of the Telco cloud, such as a host being down or video service degradation. In one example, a physical analytics engine 410, such as Smart Assurance®, can perform causal analysis to detect physical problems in the physical layer. Physical faults 413 can be sent to the ML engine 430. Meanwhile, a virtual analytics engine 405, such as vRealize® Operations (“vROPS”) can monitor KPI information to detect software problems in the virtual layer.

The virtual analytics engine 405 can report KPIs 408 to a model 415 that is being implemented by the machine learning engine 430 by, for example, reporting FPI counters 408 to the model 415. The model 415 alternatively can be implemented by a different engine, such as the correlation engine 420.

The model 415 can include thresholds generated by the temporal analysis of the ML engine 430 combined with tuning through testing self-stabilization 440. For example, if temporal analysis reveals certain KPI ranges and deviations (e.g., patterns) for a particular time of day, deviations from those ranges can be chosen as thresholds. Models 415 can incorporate the thresholds for comparison against the KPIs. Additionally, spatial analysis can reveal combinations of KPIs and faults that together commonly exist for certain problems. The ML engine 430 can use this insight to tune the models by changing the symptoms (e.g., which KPIs and/or faults together can indicate a problem). In this way, multiple models 415 can be built and tuned. The ML engine can change the model symptoms—both the KPIs themselves and thresholds they are compared to—to effectuate self-healing 435 and self-stabilization 440.

To do this analysis, the ML engine 430 can receive alerts from the physical analytics engine 410 and the virtual analytics engine 405. The ML engine 430 can map problems in one layer to the other, such as by using the correlation engine 420. As described above, the ML engine 430 can make cross-domain correlations between physical and virtual components to correlate KPI threshold alerts to physical faults. A graph database can include objects relating network components in both domains and relating to the alerts 408, 413 from the various analytics engines 405, 410. The ML engine 430 can run multiple different ML algorithms as part of the spatial and temporal analysis, such as those described previously for Table 1. The models tuned and generated from different algorithms can be tested against one another to determine the machine learning algorithms that improve network stability the most. Those algorithms can then be prioritized or used instead of the less effective algorithms.

In one example, by combining KPI-based dynamic thresholds of the virtual analytics engine 405 with symptom-based code book correlation from the physical analytics engine 410, the ML engine 430 or correlation engine 420 can generate an RCA event 423. The RCA event 423, which is a type of alert, can be used for self-prediction 445 in taking remedial actions as defined in the model. The RCA event 423 can be an object used by the correlation engine 420 or orchestrator to look up potential remedial actions, in an example. For example, a model can indicate a physical service router card contains ports, which contain interfaces, which contain virtual local area networks. Then performance-based alerts from the dynamic thresholding of the virtual analytics engine 405 can be correlated to the various model elements in the RCA event 423 using the correlation engine 420.

In one example, the RCA event 423 can be converted during self-prediction 445 into a predictive alert, which can be sent to the appropriate destination, such as the physical analytics engine 410 or an orchestrator. The predictive alert can include remedial actions for physical or virtual components in the Telco cloud, depending on the action type. The actions can pertain to virtual components such as VNFs and physical components such as physical networking and storage devices, such as routers, switches, servers, and databases.

The ML engine 430 can further analyze the impact of these alerts on self-healing 435 and self-stabilization 440 of the network. This can include both temporal and spatial analysis, and can include monitoring patterns in faults, KPIs, or alerts related to the network components implicated by the alerts.

FIG. 5 is a diagram of example ML use cases 505 related to temporal and spatial analyses 510, 520. In one example, the ML engine can perform temporal analysis 510, which can include data mining for a rate of occurrence 512, anomaly detection 514, or behavioral analysis 516. The temporal analysis 510 generally can relate to analysis for a period of time, such a particular time during a day, week, or month. As a rate of occurrence 512 example, the ML engine can establish the number of times an instance occurs in a time period, such as the number of times packet loss exceeds a threshold over a period of time.

Behavioral analysis 516 can include a correlation between physical and virtual components over a period of time. For example, the ML engine can recognize peak utilization of virtual components occurring at a particular time of day. The ML engine can also determine packet loss periodicity, growth, and anomalies during latencies and delays for virtual and physical network components. These cross-domain patterns can be incorporated into a model for predicting failures and understanding whether KPIs or faults are truly anomalous.

Anomaly detection 514 can be used to predict failures in the future. This can include recognizing any increase or decrease in a metric over a period of time with respect to baselines established based on the rate of occurrence 512 and behavioral analysis 516 outlined above. For example, video service degradation with an increase in call drop ratio can be detected as an anomaly.

These patterns and anomalies can be built into models (as symptoms and symptom thresholds) for issuing alerts. Anticipating a potential failure, the ML engine can issue an alert that causes an orchestrator to perform predictive load balancing (self-healing). For example, the orchestrator can interpret information in the alert or receive an API call that causes it to spawn a new VNF for handling calls. Similar anomalies can be detected in hardware performance attributes. For example, an increase in voltage and temperature sensor values for a physical component can cause the ML engine to issue an alert to move VNFs off of that physical device and onto another.

Spatial analysis 520 can be used to identify events that occur at the same time. For example, fault analysis 522 can include identifying other faults that occur at the same time as an anomaly detected based on KPIs or a first fault. For example, having observed that there is video service degradation for a VNF hosted on a VM, spatial analysis 520 can identify other faults occurring at the same time. For example, an increase in temperature and voltage of a physical router and packet loss increase for an MPLS component can all be correlated. The ML engine can then tune a model to include these correlated events as symptoms for detecting a problem.

Clustering analysis 526 and fault affinity analysis 524 can be used to examine the affinity of similar faults and performance data during a slice of time. For example, packet drops, call drops, throughput issues, delay, latency, processing performance, memory shortages, and other information can describe a story for an operator of an orchestrator service. Clustering analysis 526 can involve relating physical or virtual components to one another when analyzing faults. Fault affinity analysis 524 can include relating fault types to one another during the spatial analysis 520. This information can be included in the alert sent from the ML engine.

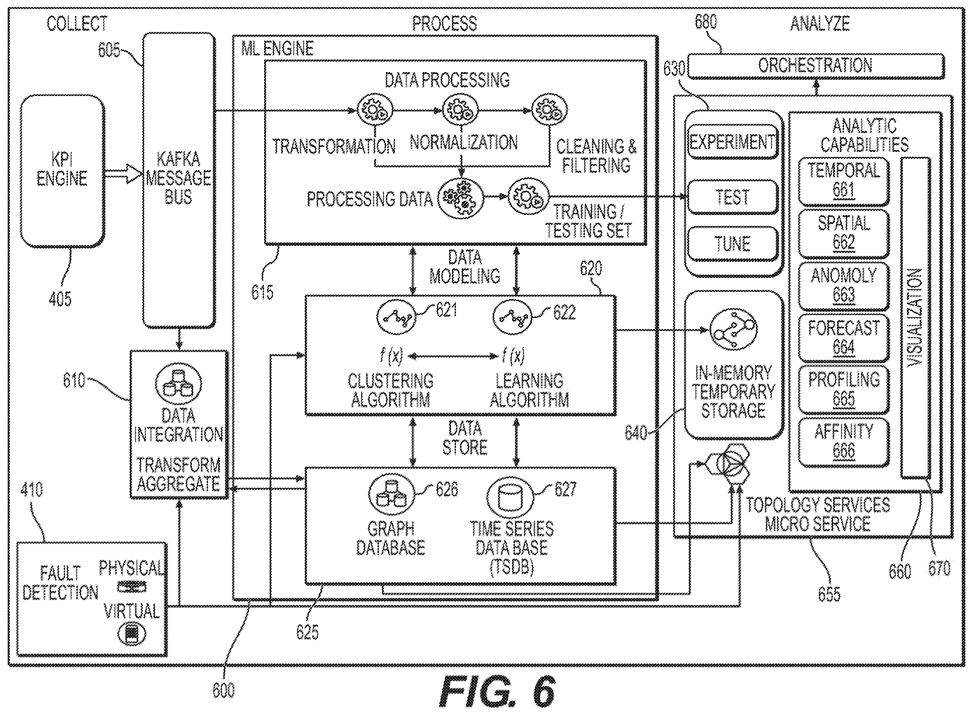

FIG. 6 is an example system architecture diagram including components and stages for self-aware service assurance in a Telco network. The system can include a KPI engine 405 and fault detection engine 410. These can be applications running on a physical server that is part of an SDDC in an example. The fault detection engine 410 can be a physical analytics engine 410, such as Smart Assurance® by VMware®. The KPI engine 405 can be vRealize® by VMware®.

The ML engine 600 can collect information from both engines 405, 410. In one example, a data integration component 610 can transform one or both of the virtual KPIs and physical faults into a format usable by the ML engine 600. In one example, KPIs can be sent on an Apache® Kafka® bus 605 to the ML engine 600 and the data integration component 610. For example, the KPI engine can place a VNF alert containing KPI information on the bus 605, in an example. The data integration component 610 can translate one or both of the KPIs and physical faults into a format used by a data store 625 of the ML engine 600. In one example, the data integration component 610 converts a virtual analytics object into an object format readable by the physical analytics engine. The common objects can then be aggregated together for use by the ML engine 600.

In one example, the data integration component 610 or ML engine 600 can send spatial data to the graph database 626. For example, nodes can be created in a graph database 626 to represent physical and virtual components of the SDDC, which can span multiple clouds. Edges between nodes can represent relationships. For example, a connection between a router node and switch node can indicate a relationship. The parent node can be a router and child can be the switch. Similarly, virtual components can be linked to physical components in this way.

The ML engine 600 can also process the KPIs using its own data processing services 615. This can allow the ML engine 600 to transform the KPIs into data that can be processed by its current models 620 for alerts purposes. The processed KPIs can also be used by the ML engine to analyze network health as part of its tuning processes 630. The data processing services 615 can transform KPIs into a useable format. KPIs can also be normalized for comparison against dynamic thresholds. A cleaning and filtering process can eliminate KPIs that are not being processed by the models 620 or analyzed by the tuning processes 630.

Both KPIs and faults can be stored in a TSDB 627 for use in temporal analysis. The TSDB 627 can store KPIs for a particular object, such as calls or packets dropped for a router or VNF. These KPIs can be stored according to time. For example, the TSDB 627 can store packet drops for a router across a day, week, month, and year.

Using this data, the ML engine 600 can perform modelling to determine when alerts and predictive actions are needed. The ML engine 600 can apply models 620 to the processed KPIs as part of detecting events in the SDDC and issuing corresponding alerts, such as to an orchestration process 680. The models 620 can incorporate at least one clustering algorithm 621 and at least one learning algorithm 622. The learning algorithm 622 can be used for temporal analysis. For example, the temporal analysis can include a linear regression ML technique. Linear regression can take an event at a first time and extrapolate something else happening at a second time. With data history, the ML engine 600 can create probabilities of failures based on these extrapolations. To do this, the learning algorithm can use information from the TSDB 627. The TSDB 627 can include a history of time-series KPIs to use for pattern recognition and establishing dynamic thresholds against which anomalies can be detected.

The clustering algorithm 621 can be used for spatial analysis to detect anomalies (faults) and affinity. This can include determining what is inside and outside of a pattern detected by the learning algorithm 622. The clustering algorithm 621 can use the graph database 626 and analyze what other faults are happening in the physical domain at the same time as an anomaly in the virtual domain.

In one example, an in-memory temporary storage 640, such as a cache, can load portions of the graph database 626 and TSDB 627 into memory for faster use. This can allow the models 620 to more quickly analyze the data. A topology microservice 655 can coordinate information between the data store 625, fault detection engine 410, and ML engine 600 to present data in a format actionable by the ML engine 600. For example, it can translate information from Smart Assurance® into something useable in the graph database 626, which is then used by the models 620 of the ML engine 600 in creating alerts.

The ML engine 600 can analyze the alerts and their impact on network health using analytics services 660. The analytics 660 can be performed for any of the use cases of FIG. 5. For example, the ML engine can perform temporal analysis 661 in a time slice and spatial analysis 662 to determine what else is happening at that time. Together, these can be used to detect anomalies 663 and forecast problems 664. These can all be outputs from the clustering and learning algorithms 621, 622, in an example. Forecasting 664 can allow management processes in the SDDC to make predictive fixes, such as reloading VMs or VNFs.

Profiling 665 can allow an operator to explore the anomaly detection 663 of the ML engine 600. Customers can focus on particular problems or KPIs to explore insights uncovered by the ML techniques. Affinity analysis 666 can allow for particular spatial analysis in a time slice, such as the use cases discussed with regard to the affinity analysis 524 and clustering analysis 526 of FIG. 5. The profiling 665 and affinity analysis 666 can be visualized 670 on a GUI for an operator, who can use the GUI to explore the relationships and insights uncovered by the ML engine.

The ML engine 600 can also analyze the network health to determine effectiveness of the alerts and, ultimately, the models 620 being used to generate the alerts. The initial algorithms 621, 622 and KPIs monitored in the models 620 can be selected by a user, such as on the GUI. But these algorithms 621, 622 can evolve over time based on analysis in the tuning process 630 employed by the ML engine 600. In one example, the ML engine 600 can experiment by utilizing different KPIs and different algorithms for making some predictive alerts. The effectiveness of the different approaches can be tested against one another over a period of time. If the change in network health from one approach is less than another, then that approach can be performed less often or discarded altogether. This can allow the ML engine 600 to evolve its models 620 based on which ones are working the best.

As an example, Table 1 above indicates various ML algorithms that can be applied for temporal analysis and spatial analysis. Different algorithms can be selected. For example, in the ML technique column of Table 1, the following algorithm types are listed: linear regression, logistic regression, k-means, hidden Markov, and Q-learning. Different variants of these algorithms can be tested and then used for tuning if they show improved network health results. For example, a Q-learning algorithm can be tested against a k-means algorithm for grouping affinity-related KPIs and faults for a given time slice and making predictions. The Q-learning algorithm can be initially selected by a user. However, based on predictions from the k-means algorithm resulting in fewer related alerts over a period of time than a normalized number of alerts from the Q-learning predictions, the ML engine 600 can prioritize using the k-means algorithm.

The ML engine 600 can run on one or more servers having one or more processors. The graph database 626 and TSDB 627 can store information on one or more memory devices that are on the same or different servers relative to one another or to the ML engine 600.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for self-aware service assurance for a software-defined data center (“SDDC”), comprising:
receiving key performance indicators (“KPIs”) of a virtual component in the SDDC;
receiving physical fault information from a physical component in the SDDC;
issuing an alert based on a model that specifies symptoms and a problem associated with the symptoms, wherein the symptoms are selected based on spatial analysis that links events at the virtual component and the physical component, wherein the symptoms include dynamic KPI thresholds, and wherein the alert notifies an orchestrator to perform a corrective action;
analyzing, by a machine learning engine, network stability related to the virtual and physical components; and
based on the analysis of network stability, tuning the model symptoms.

2. The method of claim 1, further comprising receiving, on a graphical user interface (“GUI”), a user selection of which KPIs are used as symptoms in the model, wherein adjusting the model symptoms includes changing the symptoms to a new group of KPIs discovered by spatial analytics of the machine learning engine.

3. The method of claim 1, wherein tuning the model symptoms includes changing KPI thresholds based on temporal analysis indicating a new pattern of KPI values for a period of time.

4. The method of claim 1, further comprising switching to a new machine learning algorithm based on analysis of the network stability, wherein tuning the model symptoms is based on results from the new machine learning algorithm.

5. The method of claim 1, further comprising storing the KPIs in a time series database in association with time periods, wherein the KPIs in the time series database are used to recognize KPI patterns, the KPI patterns being used to tune the model symptoms.

6. The method of claim 1, further comprising storing objects in a graph database to represent relationships between physical and virtual network components in the SDDC, wherein spatial analysis uses nodes from the graph database to determine which KPIs and faults to include as symptoms in the model.

7. The method of claim 1, wherein the model compares packet drop rates to a dynamic threshold, wherein the packet drop rates are analyzed in real time and based on historical values to determine a change to the dynamic threshold.

8. A non-transitory, computer-readable medium comprising instructions that, when executed by a processor, perform stages for self-aware service assurance for a software-defined data center (“SDDC”), the stages comprising:
receiving key performance indicators (“KPIs”) of a virtual component in the SDDC;
receiving physical fault information from a physical component in the SDDC;
issuing an alert based on a model that specifies symptoms and a problem associated with the symptoms, wherein the symptoms are selected based on spatial analysis that links events at the virtual component and the physical component, wherein the symptoms include dynamic KPI thresholds, and wherein the alert notifies an orchestrator to perform a corrective action;
analyzing, by a machine learning engine, network stability related to the virtual and physical components; and
based on the analysis of network stability, tuning the model symptoms.

9. The non-transitory, computer-readable medium of claim 8, the stages further comprising receiving, on a graphical user interface (“GUI”), a user selection of which KPIs are used as symptoms in the model, wherein adjusting the model symptoms includes changing the symptoms to a new group of KPIs discovered by spatial analytics of the machine learning engine.

10. The non-transitory, computer-readable medium of claim 8, wherein tuning the model symptoms includes changing KPI thresholds based on temporal analysis indicating a new pattern of KPI values for a period of time.

11. The non-transitory, computer-readable medium of claim 8, the stages further comprising switching to a new machine learning algorithm based on analysis of the network stability, wherein tuning the model symptoms is based on results from the new machine learning algorithm.

12. The non-transitory, computer-readable medium of claim 8, the stages further comprising storing the KPIs in a time series database in association with time periods, wherein the KPIs in the time series database are used to recognize KPI patterns, the KPI patterns being used to tune the model symptoms.

13. The non-transitory, computer-readable medium of claim 8, the stages further comprising storing objects in a graph database to represent relationships between physical and virtual network components in the SDDC, wherein spatial analysis uses nodes from the graph database to determine which KPIs and faults to include as symptoms in the model.

14. The non-transitory, computer-readable medium of claim 8, wherein the model compares packet drop rates to a dynamic threshold, wherein the packet drop rates are analyzed in real time and based on historical values to determine a change to the dynamic threshold.

15. A system for performing self-aware service assurance for a software-defined data center (“SDDC”), comprising:
a non-transitory, computer-readable medium containing instructions; and
a processor that executes the instructions perform stages comprising:
receiving key performance indicators (“KPIs”) of a virtual component in the SDDC;
receiving physical fault information from a physical component in the SDDC;
issuing an alert based on a model that specifies symptoms and a problem associated with the symptoms, wherein the symptoms are selected based on spatial analysis that links events at the virtual component and the physical component, wherein the symptoms include dynamic KPI thresholds, and wherein the alert notifies an orchestrator to perform a corrective action;
analyzing, by a machine learning engine, network stability related to the virtual and physical components; and
based on the analysis of network stability, tuning the model symptoms.

16. The system of claim 15, the stages further comprising receiving, on a graphical user interface (“GUI”), a user selection of which KPIs are used as symptoms in the model, wherein adjusting the model symptoms includes changing the symptoms to a new group of KPIs discovered by spatial analytics of the machine learning engine.

17. The system of claim 15, wherein tuning the model symptoms includes changing KPI thresholds based on temporal analysis indicating a new pattern of KPI values for a period of time.

18. The system of claim 15, the stages further comprising switching to a new machine learning algorithm based on analysis of the network stability, wherein tuning the model symptoms is based on results from the new machine learning algorithm.

19. The system of claim 15, the stages further comprising storing objects in a graph database to represent relationships between physical and virtual network components in the SDDC, wherein spatial analysis uses nodes from the graph database to determine which KPIs and faults to include as symptoms in the model.

20. The system of claim 15, wherein the model compares packet drop rates to a dynamic threshold, wherein the packet drop rates are analyzed in real time and based on historical values to determine a change to the dynamic threshold.
